(19) United States
(12) Patent Application Publication
(10) Pub. No.: US 2006/0268132 A1
(43) Pub. Date: Nov. 30, 2006

(54) Zoom Lens unit and photographic device using the same

(75) Inventor: Atsushi Oshima, Tokyo (JP)

Correspondence Address: SENNIGER POWERS, ONE METROPOLITAN SQUARE, 16TH FLOOR, ST LOUIS, MO, 63102, US

(73) Assignee: NATEC Engineering Corporation, Tokyo (JP)

(21) Appl. No.: 11/140,651

(22) Filed: May 27, 2005

(51) Int. Cl. H04N 5/262

(52) U.S. Cl. 348/240.3

(57) ABSTRACT

The present invention provides a zoom lens unit and a photographic device using the same, wherein the zoom lens unit can readily achieve position accuracy and slope accuracy of the lens, and reduce the required number of parts to lower the costs. The zoom lens unit of the present invention comprises a plurality of lens sets constituting an optical system wherein at least two lens sets thereof are movable, stepping motors for separately driving each of the at least two lens sets, and a shutter module installed in the center of the optical system, wherein the at least two lens sets and the shutter module are installed within an integral box body.

### FIELD OF THE INVENTION

The present invention relates to a construction of a zoom lens unit and a photographic device using the same.

### BACKGROUND OF THE INVENTION

Recently, it is desired that the increasingly popular digital cameras, video cameras, and photographic devices with built-in digital camera (such as mobile phones with built-in digital camera and music players with built-in digital camera) become thinner and lighter. In view of such trends, a “flection-type” zoom lens unit is widely used in the above-mentioned device, which is characterised in that a prism is installed behind the object lens and the optical axis is rotated by 90°, resulting in increased height and reduced thickness of the entire lens unit.

FIG. 1 is a cross sectional view of a conventional construction of the above-mentioned flection-type zoom lens unit. The flection-type zoom lens unit has lens sets constituting the optical system, wherein the lens sets comprise at least two movable lens sets 108, as shown in FIG. 1. In addition, in order to drive the two lens sets 108, two stepping motors 113 are employed, and a shutter module 104 is located in the center of the optical system.

Conventionally, the structure shown in FIG. 1 takes a shutter module 104 as a center, and the top and bottom portions thereof are the structure made of the top box body 106A and the bottom box body 106B. For example, protrusions are provided on the shutter module 104, and guide holes are formed on the top and bottom box bodies (106A, 106B). The positioning of the structure is achieved through the engagement between the protrusions and the guide holes. On the top end of the top box body 6A, an object lens 101 and a prism 102 are disposed. On the bottom end of the bottom box body 106B, an image detector 110 is disposed.

The movable lens mounts 107A and 107B may move upwards and downwards, being supported respectively by two guide rods (105A, 105A′, and 105B, 105B′) on the right and left respectively. The actuating force of the movement comes from the assembly of a bolt 109 and a nut 111 coupled to a stepping motor 103. To detect the upper and lower limited positions of the moving range of the movable lens mounts, two photo-interrupters PI are disposed on each of the box bodies respectively. a mask 113 extending into the gap of the photo-interrupters is disposed on the lens movable mount 107.

FIG. 2 is a side view of the zoom lens unit in FIG. 1 (the motors and the guide rods are omitted). The light passing through the object lens 101 are reflected into a downward direction by the prism 102.

FIG. 3 shows the zooming action of the zoom lens unit in FIG. 1. FIG. 3 depicts the position relationship between the two zoom lenses 108, which locate at the focal length sites. Generally, one part moves in a linear manner, and the other part moves along a curve.

Additionally, in conventional zoom lens, cams carved with linear and curved grooves control the movement of the two lenses; whereas, in the flection-type zoom lens, two stepping motors 103 are used to actuate the two lenses 108.

FIG. 4 is a schematic diagram showing the CPU and motor driver for actuating the conventional zoom lens unit in FIG. 1. The actuation of the stepping motor 108 is controlled by the CPU. The position relationship between the two zoom lenses 108 are set in the program for the CPU.

FIG. 5 is a diagram showing the relationship between the moving range of the two lens sets 108 and the four photo-interrupters (PI). The origin positions of the two movable lenses 108 are determined by the four photo-interrupters (PI). In the case of the lenses being driven by the stepping motors 103, the origin positions of the lenses must be determined. When the power is ON, the signal of the photo-interrupter PI is detected as a position-setting reference for each movable lens 108. To achieve the above-mentioned objects, one photo-interrupter can be disposed on each movable lens. Further, when the stepping motor 103 can not operate properly due to certain reason, the movable lenses 108 can be prevented from moving beyond designed range by installing four photo-interrupters (PI). If the movable lens moves beyond the normal range, the movable lenses 108 would collide with the box body or other lenses. Then, the bolt and the nut may engage together too firmly that the movable lenses 108 are stuck in the position and cannot be moved to other positions by the stepping motor 103. The above must be prevented at all cost. Thus, two photo-interrupters (PI) are respectively disposed adjacent to the two ends for the normal moving range of the movable lens, for monitoring the movements of the movable lens 108; should the movable lens 108 move beyond the position, the position of the lens 108 may be reset by the control program.

The above-mentioned zoom lens is characterized by driving two lens sets with stepping motors, as compared to more conventional zoom lens in which the movement of the two lenses are controlled by the cam carved with linear and curved grooves. Accordingly, the structure is simplified, and expensive parts may be omitted, and the assembling of the lens unit is simplified. However, the following problems still exist.

FIG. 6 is a cross sectional view of a conventional zoom lens, which is made by assembling the top and bottom box bodies with bad precision such that the top and bottom box bodies displaced slightly toward right and left respectively. As shown in FIG. 6, a shutter module 104 is located in the center of the zoom lens optical system. Since the shutter module 104 is formed into a structure combined by separate constructions at the top and bottom thereof, the position error of each lens set readily occurs, which causes the optical performance impaired. If the differences in position and size between the protrusions on the above-mentioned shutter modules 104 and the guide holes on the box body (106A, 106B) cause the dislocation between the top and bottom box bodies (106A, 106B) in the horizontal direction, the displacement of the optical axis also takes place. In addition, if position dislocation occurs between the box bodies (106A, 106B) and the shutter module 104, the guide rod 105 disposed between them and the lens mount 107 assembled on the guide rod may be sloped. These cases are rather bad in optics, which may cause the problems such as deteriorated image resolution for the image detector 110, and hazy image corners.

In addition, since the length of the supporter of the lens mount 107 that jacketed on the guide rod 105 is limited by the shutter module 104 located in the center position, thus being insufficient, the lens mount 107 is prone to be sloped, which may cause the optical performance impaired. In particular, as shown in FIG. 7, the relationship between the movable lens mount 107 and the guide rod 105 is illustrated, and circular holes are formed on the supporter in FIG. 7 for the guide rod 105 to pass through. The diameter of the hole needs to be larger than that of the guide rod 105. If the diameter of the hole is smaller that that of the guide rod 105, the lens mount 107 may be fixed, likewise, if the diameter of the hole is equal to that of the guide rod 105, the guide rod 105 cannot move smoothly either. That is, it should be assembled in such a way that there is a gap between the frame and guide rod 105. Since there are gaps, the lens mount 107 may be slightly sloped relative to the guide rod 105, and if the length of the supporter becomes short, the slope may become larger.

In addition to the above-mentioned problems, in the conventional flection-type zoom lens, there are two sets of movable lens mounts and a total of four photo-interrupters are installed, thus the costs for both assembling-and parts increase, making cost a problem.

The present invention is created to solve the problems in the above-mentioned conventional flection-type zoom lens, with the object that positioning accuracy and slope accuracy could be readily achieved in flection-type zoom lens unit, and the required number of parts is decreased to lower the costs.

### SUMMARY OF THE INVENTION

In order to achieve the above-mentioned objects, the present invention provides a zoom lens unit comprising a plurality of lens sets constituting an optical system wherein at least two lens sets thereof are movable, stepping motors for separately driving each of the at least two lens sets, and a shutter module installed in the center of the optical system, wherein the at least two lens sets and the shutter module are installed within an integral box body.

It is preferred that three guide rods are mounted on a top plate and a bottom plate of the integral box body, and each of the at least two lens sets are coupled respectively to at least two of said three guide rods in a way such that each of the lens sets can move freely along the optical axis direction and that one of said three guide rods is commonly coupled to said at least two lens sets.

The aforementioned shutter module does not completely divide the inner space of the integral box body into upper and lower parts, but instead is mounted in such a way that spaces are left beside said shutter module for the guide rods and supporters of the at least two lens sets which are movable to pass through.

Photo-interrupters are disposed to detect the positions of the above-mentioned two movable lens sets. Preferably, at least one of the photo-interrupters is commonly used to detect the positions of the two movable lens sets.

The above-mentioned zoom lens may further comprise an object lens and a prism installed behind the object lens such that the optical axis is rotated by 90° and the lens sets can be installed on the rotated optical axis direction, so as to increase the height and the decrease thickness of the entire unit.

The subject invention also provides photographic device comprising the above zoom lens unit. The photographic device may be, for example, a digital camera, video camera, or any device with built-in digital camera.

### BRIEF DESCRIPTION OF THE DRAWINGS

FIG. 1 is a cross sectional view of the typical structure of a conventional flection-type zoom lens.

FIG. 2 is a side view of the conventional zoom lens unit in FIG. 1.

FIG. 3 shows the zooming action of the conventional zoom lens unit in FIG. 1.

FIG. 4 is a schematic diagram showing the CPU and motor driver for actuating the conventional zoom lens unit in FIG. 1.

FIG. 5 is a diagram showing the relationship between the moving range of two lens sets and four photo-interrupters (PI).

FIG. 6 is a cross sectional view of the conventional zoom lens, which is assembled with the top and bottom box bodies thereof displaced slightly toward right and left respectively.

FIG. 7 is a diagram illustrating the relationship between movable lens mount and guide rods.

FIG. 8 is a cross sectional view of a zoom lens unit of the present invention.

FIG. 9 shows the action of four photo-interrupters in a conventional zoom lens.

FIG. 10 shows the action of three photo-interrupters according to present invention.

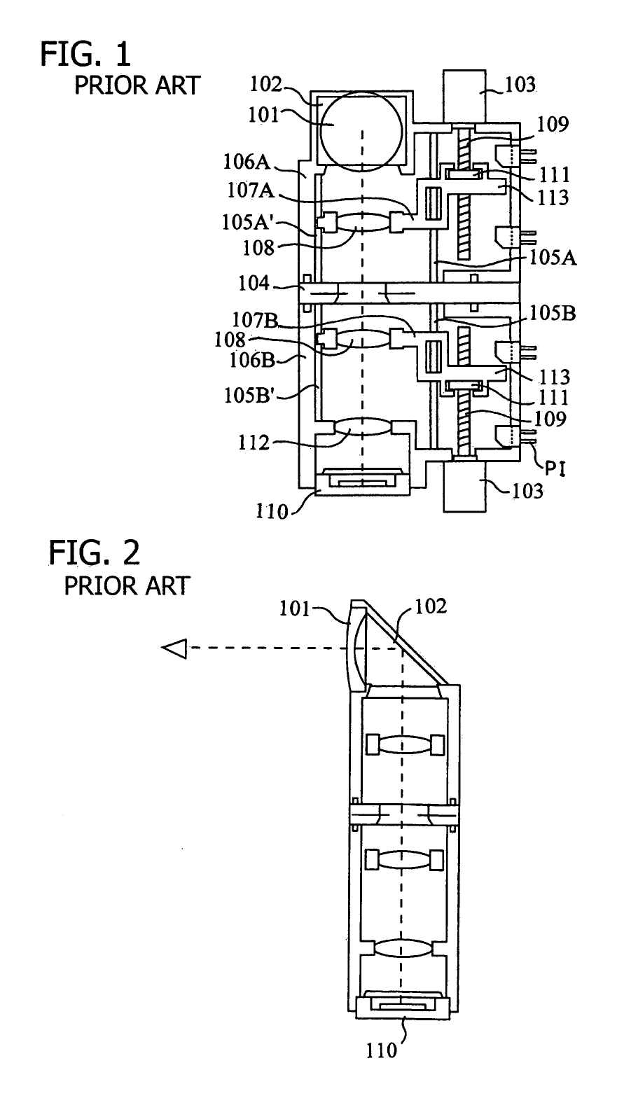

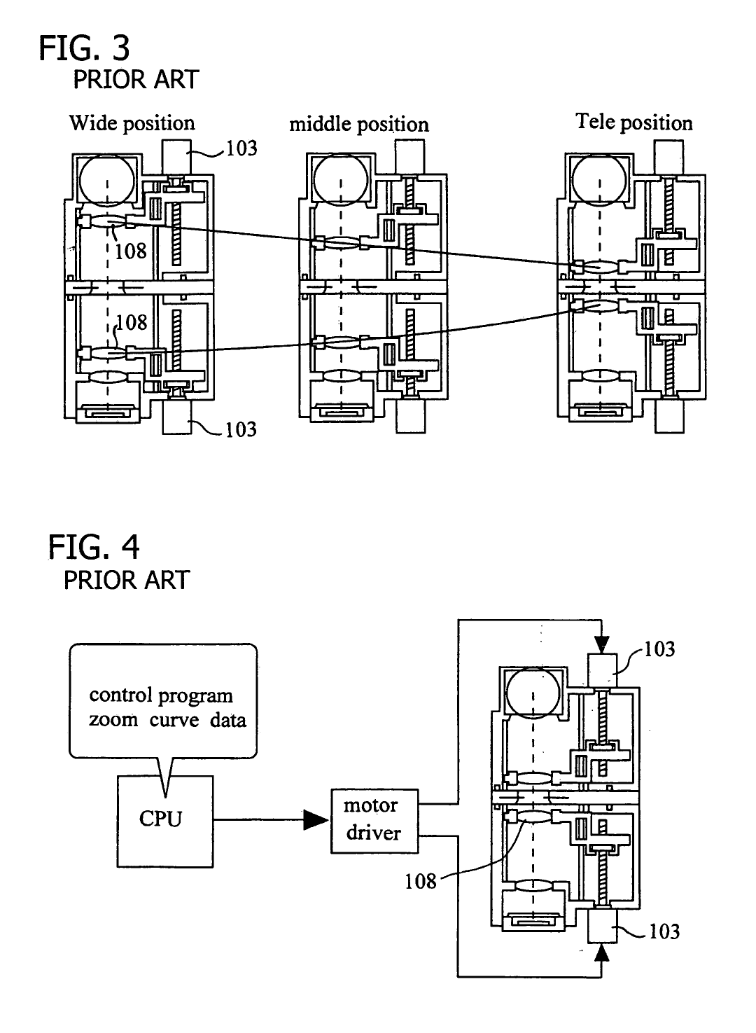

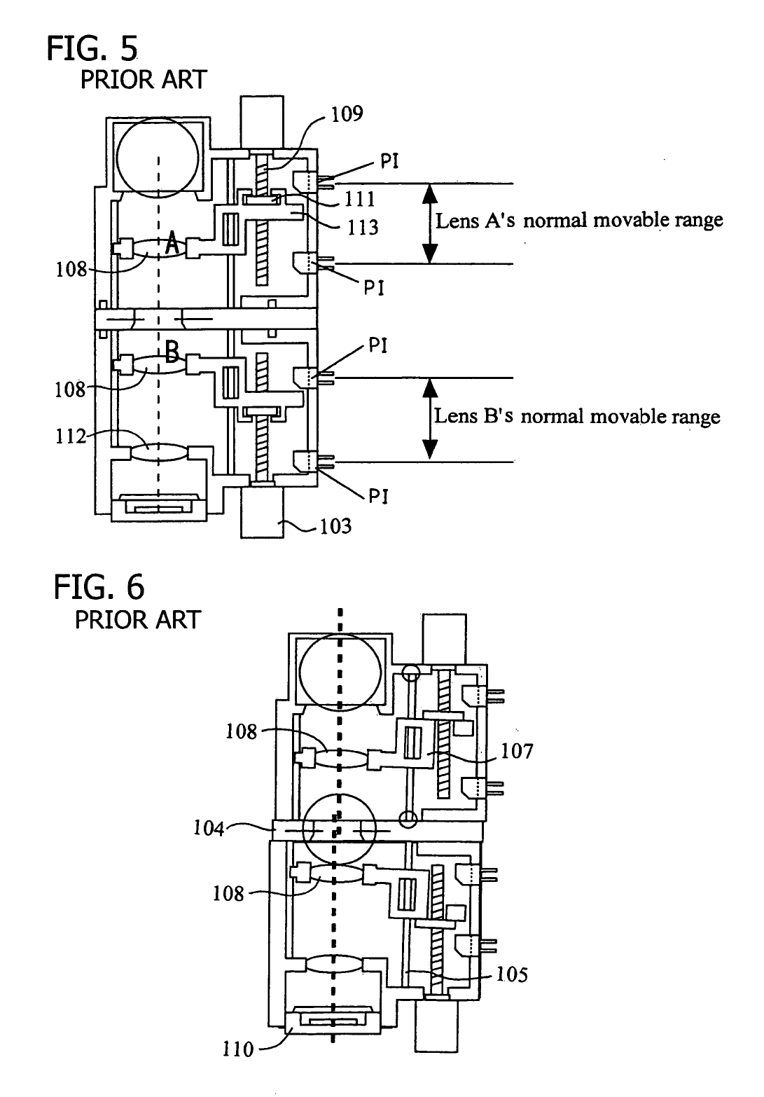

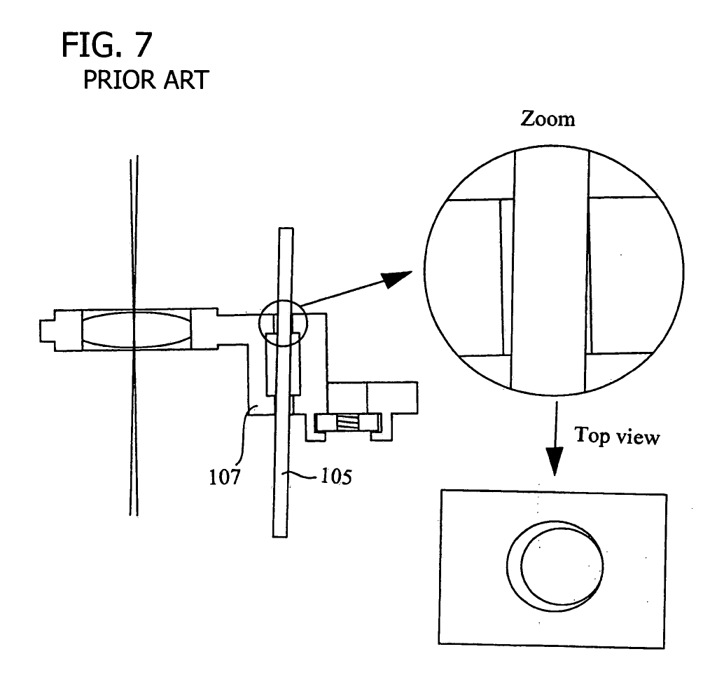

### DETAILED DESCRIPTION OF THE INVENTION

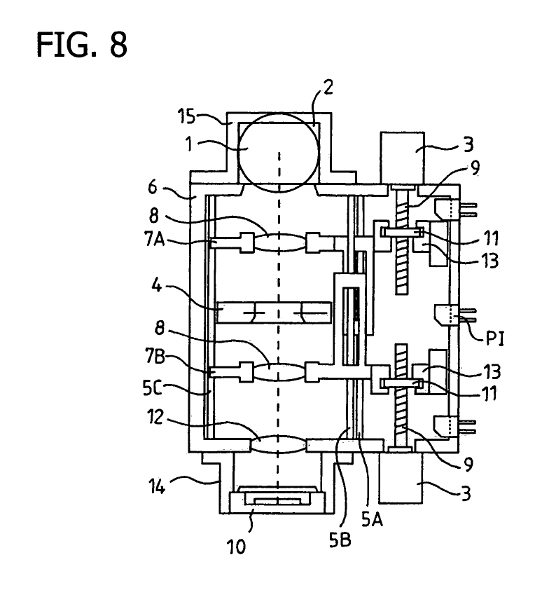

FIG. 8 is a cross sectional view of a preferred zoom lens unit according to the present invention. As shown in FIG. 8, a prism box 15 is installed on the top end of the zoom lens, and an object lens 1 is installed within the prism box; and behind the object lens 1, a prism 2 is installed to rotate the optical axis by 90°. The lens sets constituting the zoom lens optical system are disposed on the optical axis direction. The lens sets comprise two movable lens sets 8. The two lens sets 8 are actuated by two stepping motors 3 which are controlled by a CPU, and the position relationship between the two lens sets 8 have been set in the programs for the CPU.

The box body 6 accommodating the two movable lens sets 8 is formed as an integral box. As compared with the assembled box body in the conventional zoom lens, the integral construction can achieve a box body with higher accuracy.

Within the integral main box body 8, a shutter module 4 and three guide rods (5A, 5B, 5C) are disposed. The shutter module 4 does not divide the inner space of the integral box body into upper and lower portions completely, but is instead mounted in such a way that spaces are left beside the shutter for the guide rods (5A, 5B, 5C) and the supporters (casing pipe) of the frame (7A, 7B) of the movable lens sets to pass through.

For the two movable lenses, the movable lens mount 7A is disposed on the guide rod 5A, and the movable lens mount 7B is disposed on the guide rod 5B, which lens mounts can move upwards and downwards. A guide rod 5C is used for inhibiting the rotation of the lens mounts (7A, 7B), which is shared by both lens mounts (7A, 7B). The main box body 6 is formed as an integral box, which can prevent the possible positional dislocation of the guide rods in the top and bottom direction in the assembled construction, thus avoiding the sloping problem of the guide rods. And three disposed guide rods (5A, 5B, 5C) are not prone to be sloped.

Further, dedicated guide rod 5A and guide rod 5B are disposed respectively on the two movable lens mounts (7A, 7B). And there is a distance between the positions of the guide rods in the front and behind directions to avoid the conflicts between the two rods. The combination of the two movable lens mounts (7A, 7B) and the dedicated guide rods (5A, 5B) are conducted by assembling the casing pipes of the two movable lens mounts (7A, 7B) onto the dedicated guide rods (5A, 5B) respectively. Thereby, the supporters (casing pipe) of the movable lens mounts (7A, 7B) can maintain sufficient length. The length of the supporters (casing pipe) can be calculated by subtracting the inner height of the integral main box body 6 with the moving amount of lens. As a result, the slope caused by the gap between the movable lens mounts (7A, 7B) and guide rods (5A, 5B) is reduced.

Also, as compared with the four photo-interrupters (PI) installed for detecting the moving ranges of the lens in the conventional zoom lens, there are only three photo-interrupters in the present invention. As illustrated above, since the space within the main box body 6 is not divided completely into upper and lower portions by the shutter module 4, the central photo-interrupter among the three photo-interrupters can be shared to detect the positions of both the top movable lens set 8 and the bottom movable lens set 8. The three photo-interrupters are one less than the four photo-interrupters required in conventional devices, thus, the costs for such part is reduced, and the assembling process is also simplified further.

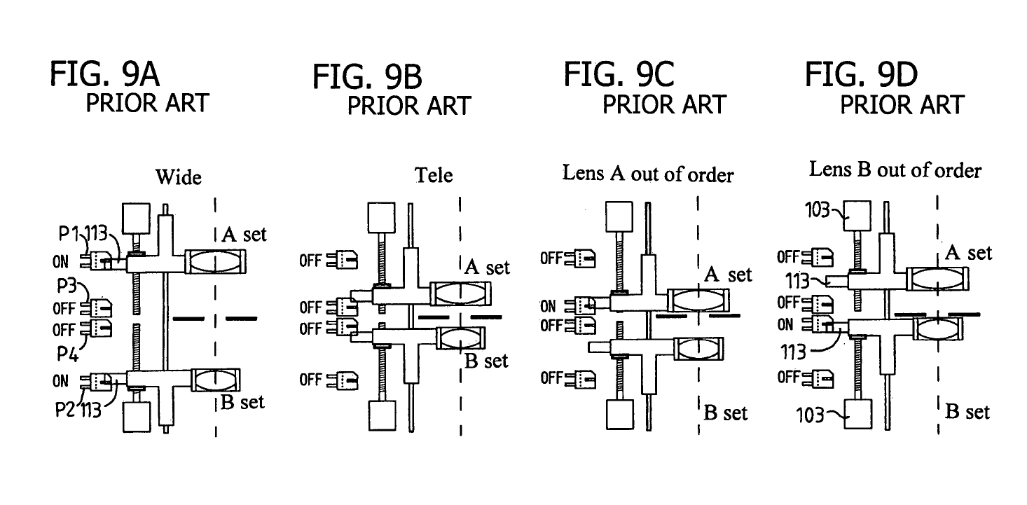

FIG. 9 shows the action of four photo-interrupters in a conventional zoom lens. FIG. 9A depicts that when the zoom lens is set in the Wide position in which the focal length is the shortest, the mask plates 113 interlocked with set A and set B reach the positions of the photo-interrupters P1 and P2 respectively, and the photo-interrupters are in an ON state. FIG. 9B depicts that when the zoom lens is set in the Tele position in which the focal length is the longest, the mask plates 113 interlocked with set A and set B approach the photo-interrupters P3 and P4 respectively, which are not in an ON state. FIG. 9C depicts that when set A moves downward beyond the Tele position, the mask plate interlocked with set A reaches the position of P3. Then the state of P3 is detected, and if it is ON, it can be determined that driving abnormality occurs to set A. FIG. 9D depicts that when set B moves upward beyond the Tele position, the mask plate interlocked with set B reaches the position of P4. Then the state of P4 is detected, and if it is ON, it can be determined that driving abnormality occurs to set B. Through the above steps, the problem that the position cannot be shifted by the stepping motor 103 can be avoided, but since four photo-interrupters are needed, it is disadvantageous in terms of costs.

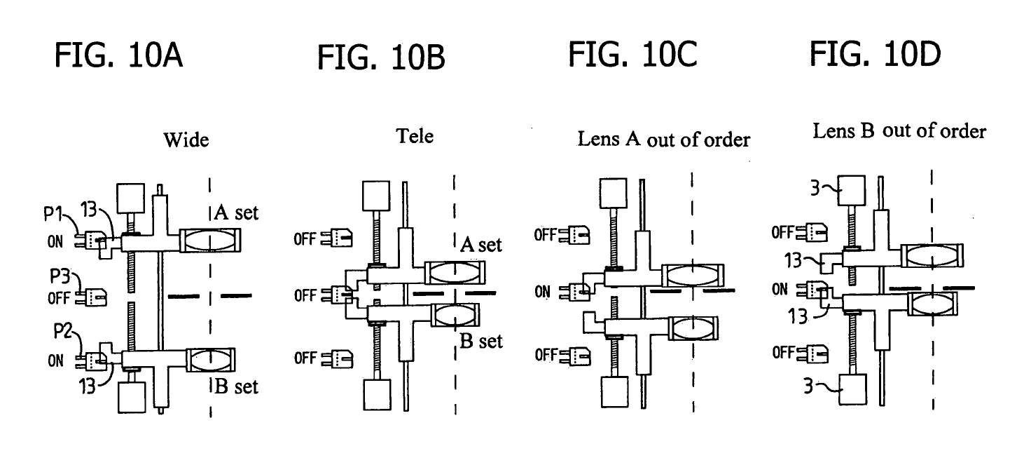

FIG. 10 shows the action of three photo-interrupters in the present invention. FIG. 10A depicts that when the zoom lens is set in the Wide position, the mask plates 13 interlocked with set A and set B reach the positions of photo-interrupters P1 and P2 respectively, and the photo-interrupters are in an ON state. FIG. 10B depicts that when the zoom lens is set in the Tele position, both mask plates 13 interlocked with set A and set B approach the photo-interrupter P3, but P3 is not in an ON state. FIG. 10C depicts that when set A moves downward beyond the Tele position, the mask plate 13 interlocked with set A reach the position of P3. Then the state of P3 is detected, and if it is ON, it can be determined that driving abnormality occurs to set A. FIG. 10D depicts that when set B moves upward beyond the Tele position, the mask plate 13 interlocked with set B reach the position of P3. Then the state of P3 is detected, and if it is ON, it can be determined that driving abnormality occurs to set B.

As mentioned above, although the construction according to the present invention comprises only three photo-interrupters, if the state of P3 is detected to be ON, it can be determined that driving abnormality occurs to either set B or set A. Although it is impossible to know for sure which one of set A and set B having driving abnormality, actually no problems will arise. When driving abnormality is detected, simply by moving set A and set B into the positions of P1 and P2 for resetting, the lens system can resume its normal state. In addition, omitting one photo-interrupter from four photo-interrupters can reduce the costs. And since the action and detection of three photo-interrupters are simpler, the costs for the assemblage and developing control software are reduced.

As mentioned above, according to the detailed descriptions of the present invention, a zoom lens unit with high lens position accuracy can be provided, and high slope accuracy can be achieved therein. Furthermore, the construction of the zoom lens is simplified, and the number of parts is reduced, so with the costs.

1. A zoom lens unit, comprising a plurality of lens sets constituting an optical system wherein at least two lens sets thereof are movable, stepping motors for separately driving each of the at least two lens sets which are movable, and a shutter module installed in the center of the optical system, wherein the at least two lens sets and the shutter module are installed within an integral box body.

2. The zoom lens unit as claimed in claim 1, wherein three guide rods are mounted on a top plate and a bottom plate of the integral box body, and each of the at least two lens sets are coupled respectively to at least two of said three guide rods in a way such that each of the lens sets can move freely along the optical axis direction and that one of said three guide rods is commonly coupled to said at least two lens sets.

3. The zoom lens unit as claimed in claim 2, wherein the one guide rod which is commonly coupled to said at least two lens sets is used for preventing each of the at least two lens sets from rotating.

4. The zoom lens unit as claimed in claim 3, wherein the shutter module does not completely divide the inner space of the integral box body into upper and lower parts, but instead is mounted in such a way that spaces are left beside said shutter module for the guide rods and supporters of the at least two lens sets which are movable to pass through.

5. The zoom lens unit as claimed in claim 4, wherein photo-interrupters are disposed to detect the positions of the at least two lens sets which are movable, and at least one of the photo-interrupters is commonly used to detect the positions of the at least two lens sets.

6. The zoom lens unit as claimed in claim 1, further comprising an object lens and a prism installed behind the object lens such that the optical axis is rotated by 90° and the lens sets can be installed on the rotated optical axis direction.

7. A photographic device comprising the zoom lens unit as claimed in claim 1.

8. The photographic device as claimed in claim 7, which is a digital camera.

9. The photographic device as claimed in claim 7, which is a video camera.

10. The photographic device as claimed in claim 7, which is a device with built-in digital camera.
